(19) United States
(12) Patent Application Publication
(10) Pub. No.: US 2015/0177196 A1
(43) Pub. Date: Jun. 25, 2015

(54) Differential Humidity Sensor

(71) Applicant: MATRIX SENSORS, INC., San Diego, CA (US)

(72) Inventors: Heinrich Sussner, Palo Alto, CA (US); Paul R. Wilkinson, El Segundo, CA (US)

(73) Assignee: MATRIX SENSORS, INC., San Diego, CA (US)

(21) Appl. No.: 14/137,990

(22) Filed: Dec. 20, 2013

(51) Int. Cl. G01N 29/24; G01N 27/22

(52) U.S. Cl. CPC G01N 29/2406; G01N 27/223; G01N 2291/101

(57) ABSTRACT

A sensor array includes at least first and second resonator sensors. A receptor material on the first sensor is hydrophilic relative to a receptor material on the second sensor, and the receptor material on the second sensor is hydrophobic relative to the receptor material on the first sensor. At least one detector measures sensor responses when masses of one or more of substances are adsorbed or bound to the sensors. A processor receives signals or data representative of the sensor responses. The processor is programmed to determine at least one humidity value according to the sensor responses.

### BACKGROUND

The invention relates to sensor arrays for detecting substances, and in particular to sensors for detecting relative humidity.

Conventional humidity sensors measure the effect of water adsorption in certain materials, such as polymers. In most cases, the adsorption of water leads to a change of capacitance (due to the increased dielectric permittivity and/or a change in dimensions). While the measurement principle is straight forward, this technique does not have the ability to distinguish between water and other adsorbed gases or vapors, changes in temperature, or time dependent changes of the detecting polymer itself. A “one variable” detector may not distinguish between different sources of the observed changes, and thus detection may be inherently inaccurate.

Resonant sensors use target molecules adsorbed in the sensing material to change properties that are reflected in the resonance frequency. A wide variety of cantilever, membrane and piezoelectric resonator-based sensors have been fabricated using MEMS technology. These sensors generally detect agents through the use of polymer films and coatings with selective adsorption for a specific agent or set of agents. Although these sensors provide a certain degree of sensitivity, it is desirable in many applications to have sensors with even higher sensitivities.

A capacitive micromachined ultrasonic transducer (cMUT) is a micromachined device having a substrate and a membrane supported above the substrate by an insulating material. A variable voltage applied between the substrate and membrane drives the membrane to vibrate and emit sound waves at ultrasonic frequencies. Arrays of cMUTs have been used for transmitting and receiving ultrasonic beam patterns in air and water over a frequency range from 10 kHz to 100 MHz. These cMUTs rely on the very large electric field (E>10⁸ V/m) in the gap of the capacitor to provide an electromechanical coupling coefficient close to unity.

cMUTs are mostly used for medical imaging. In addition, they have been used to indirectly measure various fluid characteristics, based on processing of ultrasonic signals transmitted and received through the fluid. To ensure reliable and consistent operation, cMUT membranes are normally designed to be non-reactive to chemicals, light, and other environmental factors that may alter or interfere with their operational characteristics. However, due to their resonant character, cMUT devices have the potential to be used as sensors, in a manner similar to MEMS cantilever, membrane, and piezoelectric resonator-based sensors.

U.S. Pat. No. 7,305,883 to Khuri-Yakub discloses such an arrays of sensors. Sensor elements include a functionalized membrane supported over a substrate by a support frame. The sensor element is connected to an electrical circuit, which is configured to operate the sensor element at or near an open circuit resonance condition. The mechanical resonance frequency of the functionalized membrane is responsive to binding of an agent to the membrane. The exterior surface of each sensor membrane is chemically functionalized to have an affinity for one or more specific, predetermined chemicals. A detector provides a sensor output responsive to the mechanical resonance frequency of the sensor element.

U.S. Pat. No. 8,424,370 to Cable and Steiert discloses a method for analyzing liquid samples by applying a liquid to a cMUT device having an array of sensors, drying the sensors, and electronically detecting an agent bound to each of the plurality of sensors. An electrical circuit provides a sensor output responsive to a mechanical resonance frequency of the sensor. The exterior surface of sensor membrane is chemically functionalized to have an affinity for one or more specific, predetermined chemicals. The mechanical resonance frequency of the sensor is responsive to the binding of an agent to the functionalized membrane, and the mass of the agent bound to each of the sensors may be determined.

A resonating member of a sensor, such as a functionalized membrane, may generally detect agents through the use of polymer films and coatings with selective adsorption for specific agents or set of agents. Certain polymers are often sensitive to relative humidity, for example, some of the polymers used to detect CO₂ or volatile organic compounds (VOCs). In real world operating conditions, the measurements of resonance frequencies may be significantly affected by relative humidity, temperature and interfering gases, thereby masking a true signal or substance of interest. A problem to be solved is how to account for these environmental disturbances.

### SUMMARY

According to one aspect, a device comprises a sensor array including at least first and second resonator sensors, wherein each of the first and second sensors has a receptor material disposed thereon for adsorbing or binding one or more substances. The receptor material on the first sensor is hydrophilic relative to the receptor material on the second sensor, and the receptor material on the second sensor is hydrophobic relative to the receptor material on the first sensor. The device also comprises at least one detector for detecting sensor responses when masses of one or more of the substances are adsorbed or bound to the sensors. At least one processor is in communication with the detector for receiving signals or data representative of the sensor responses. The processor is programmed to determine at least one humidity value according to the sensor responses.

According to another aspect, a method comprises exposing a sensor array to a sample. The sensor array includes at least first and second resonator sensors. Each of the first and second sensors has a receptor material disposed thereon for adsorbing or binding one or more substances. The receptor material on the first sensor is hydrophilic relative to the receptor material on the second sensor, and the receptor material on the second sensor is hydrophobic relative to the receptor material on the first sensor. The method also comprises the steps of detecting sensor responses to the sample, and employing at least one processor to determine at least one humidity value according to the sensor responses.

### BRIEF DESCRIPTION OF THE DRAWINGS

The foregoing aspects and advantages of the present invention will become better understood upon reading the following detailed description and upon reference to the drawings where:

FIG. 1 shows a schematic, cross-sectional view of a sensor according to one embodiment of the invention.

FIG. 2 shows a schematic cross-sectional view, of a sensor according to another embodiment of the invention.

FIG. 3 shows an example of an electrical circuit for a sensor according to some embodiments of the invention.

FIG. 4 shows a schematic, cross-sectional view of an array of sensors according to some embodiments of the invention.

FIG. 5 shows a schematic, plan view of an array of sensors according to some embodiments of the invention.

FIG. 6 shows a plan view of a sensor array according to another embodiment of the invention.

FIGS. 7A-7D are graphs showing masses adsorbed on sensors in an array according to some embodiments of the invention.

FIG. 8 is a flow chart showing steps of a method employing at least one processor to process data and determine values according to some embodiments of the invention.

FIG. 9 is a flow chart showing steps of a method employing at least one processor to correct a humidity value for the effects of interfering substances according to some embodiments of the invention.

FIG. 10 is a graph showing masses adsorbed on sensors in an array according to another embodiment of the invention

FIG. 11 is a graph showing masses adsorbed on sensors in an array according to some embodiments of the invention.

FIG. 12 shows a schematic, plan view of an array of sensors according to another embodiment of the invention.

FIG. 13 is a graph showing a calibration curve for mass loading and humidity according to some embodiments of the invention.

FIG. 14 is a graph showing a calibration curve for differences in mass loading and humidity according to some embodiments of the invention.

FIG. 15 is a graph showing a calibration curve for the thickness of a receptor material according to some embodiments of the invention.

FIG. 16 is a graph showing mass loading on a sensor as a function of the thickness of a receptor material on the sensor, with and without interfering substances, according to some embodiments of the invention.

### DETAILED DESCRIPTION OF PREFERRED EMBODIMENTS

In the following description, it is understood that all recited connections between structures can be direct operative connections or indirect operative connections through intermediary structures. A set of elements includes one or more elements. Any recitation of an element is understood to refer to at least one element. A plurality of elements includes at least two elements. Unless otherwise required, any described method steps need not be necessarily performed in a particular illustrated order. A first element (e.g. a signal or data) derived from a second element encompasses a first element equal to the second element, as well as a first element generated by processing the second element and optionally other data. Making a determination or decision according to a parameter encompasses making the determination or decision according to the parameter and optionally according to other data. Unless otherwise specified, an indicator of some quantity/data may be the quantity/data itself, or an indicator different from the quantity/data itself. Computer programs described in some embodiments of the present invention may be stand-alone software entities or sub-entities (e.g., subroutines, code objects) of other computer programs. Computer readable media encompass non-transitory media such as magnetic, optic, and semiconductor storage media (e.g. hard drives, optical disks, flash memory, DRAM), as well as communications links such as conductive cables and fiber optic links According to some embodiments, the present invention provides, inter alia, computer systems comprising hardware (e.g. one or more processors and associated memory) programmed to perform the methods described herein, as well as computer-readable media encoding instructions to perform the methods described herein.

The following description illustrates embodiments of the invention by way of example and not necessarily by way of limitation.

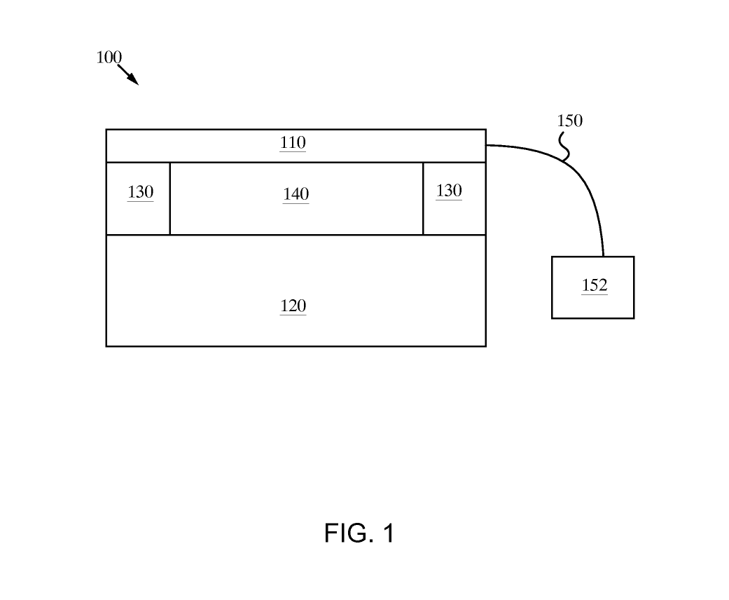

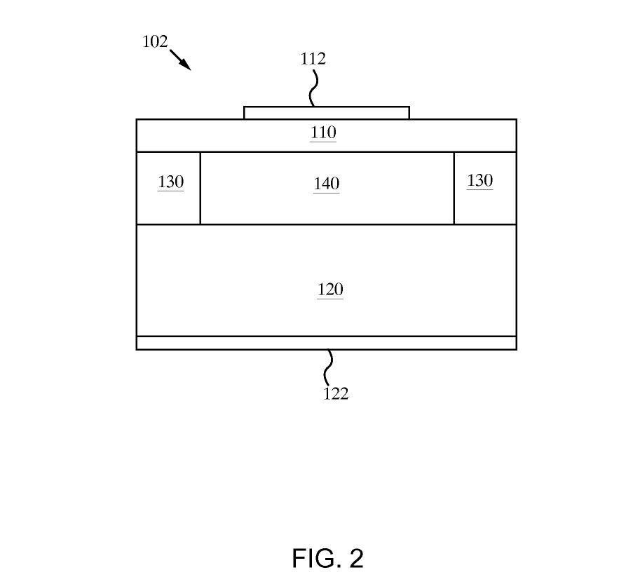

FIGS. 1 and 2 shows schematic cross-sectional diagrams of two examples of resonator sensors according to some embodiments of the invention. Resonator sensors include, without limitation, capacitive micromachined ultrasonic transducer (cMUT), cantilever, quartz crystal microbalances, and piezoelectric resonator-based sensors. FIG. 1 shows a cMUT sensor 100 that has a functionalized membrane 110, which is functionalized with a receptor material for adsorbing or binding one or more analytes. Functionalized membrane 110 is supported over a substrate 120 by support frame 130. Functionalized membrane 110, support frame 130 and substrate 120 define a vacuum gap 140. Vacuum gap 140 is preferably between about 0.1 μm and about 0.5 μm in height. The sensor 100 is connected to a detector 150 through connector 152. In general, detector 152 preferably employs a detection modality to measure a sensor response (e.g., a change in the position or resonance frequency of the membrane 110) due to the mass of one or more analytes adsorbed or bound to the sensor 100. In preferred embodiments, detector 150 detects a resonance frequency of the functionalized membrane 110, which frequency may change due to the mass of one or more substances adsorbed or bound to the receptor material on the sensor 100. Suitable detectors include, but are not limited to, an optical detector, a mechanical stress detector, a magnetic detector, and a capacitance detector.

In one embodiment, functionalized membrane 110 is driven thermally (by applied heat or by thermal noise) or electrically, and an optical detector is used to detect deflection or resonant frequency shifts of functionalized membrane 110. Interferometric optical detection techniques re described in U.S. Pat. No. 6,567,572, by Degertekin et al., which is incorporated herein by reference. In other embodiments, functionalized membrane 110 has thin piezoelectric or magnetic films that provide coupling. The resonant functionalized membranes 110 may be addressed by capacitor action (cMUTs), by a piezoelectric thin film (pMUTs), or by a magnetic film on the surface (mMUTs). Alternatively, a change in membrane deformation may be detected directly through a change in capacitance, or magnetic field, or piezoelectric signal, or change in resistance through the piezoresistive effect, or optically using an interferometer, or any other detection modality to measure the response of sensor 100 due to the mass of one or more analytes adsorbed or bound to the receptor material on the sensor 100, or due to a stiffening effect of the receptor material. Preferably, functionalized membrane 110 operates at a mechanical resonance frequency of at least about 1 MHz, more preferably between about 1 MHz and about 100 MHz.

FIG. 2 shows a cMUT sensor 102 having a functionalized membrane 110 that includes a first electrode 112. The substrate 120 contains a second electrode 122. Functionalized membrane 110 and substrate 120 are preferably thin membranes that are essentially parallel plate capacitors with a gap between the plates. In a preferred aspect of this embodiment, the conductive silicon wafer on which the functionalized membrane is fabricated, i.e. substrate 120, makes up one plate of the capacitor. A metal electrode 112 on top of the functionalized membrane 110 is the other plate of the capacitor. Functionalized membrane 110, which is supported by insulating support frame 130, is typically made of an insulating material, most commonly silicon, and is coated with the electrode 112. A low temperature oxide passivation layer may cover electrode 112 and functionalized membrane 110.

In some embodiments, functionalized membrane 110 is constructed to have a large surface area, for instance by adding vertical trenches, by making a portion of the membrane porous, or by adding cavities. Each of the cavities may be formed with a specific dimension based upon the desired resonant frequency. Each of the plurality of cavities is then configured to communicate with a common electrode, which thereby forms a single sensor. This way, it is possible to attach many more molecules of a species to the membrane and increase the mass loading or induced stress, and hence improve sensitivity.

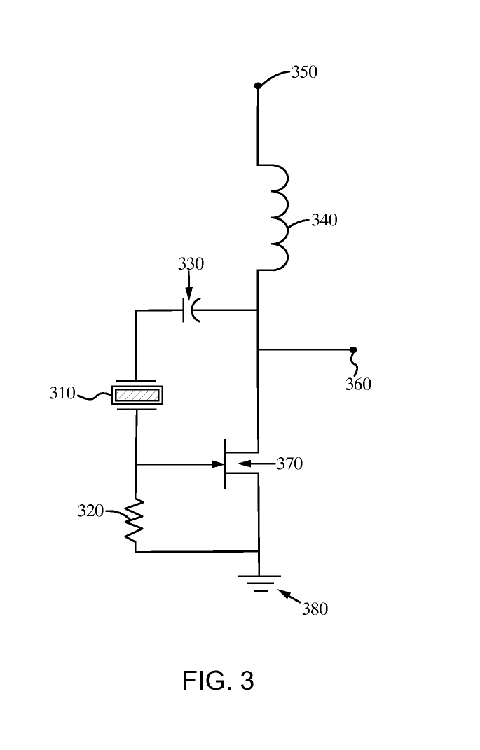

FIG. 3 shows one embodiment of a circuit suitable for use with a sensor. The circuit is one variation of a so-called Pierce oscillator. The circuit includes sensor element 310, resistor 320, capacitor 330, inductor 340, DC voltage source 350, sensor output 360, transistor 370, and connection to ground 380. Many other circuits are available to establish a resonant circuit using the sensor's resonant electrical input impedance. The output of these circuits is a sinusoidal signal whose frequency is the measurable quantity of interest.

In some embodiments, the sensor is placed in the feedback loop of an amplifier and the gain of the amplifier is adjusted such that the circuit oscillates. The frequency of the oscillator is tuned by adjusting the DC bias that is applied to the sensor element. By controlling this DC bias the resonance or oscillation frequency is placed near the open circuit resonant frequency of the sensor. This is done in order to reduce the noise in the oscillator circuit, and hence increase the sensitivity of the sensor. When analyte adsorbs or binds to the receptor material on a resonating member of the sensor (e.g., the membrane 110 or a cantilever), its open circuit resonance frequency shifts, and this imparts a frequency shift in the oscillator circuit. By measuring the resonance frequency of the oscillator, one can tell how much mass has deposited on the membrane 110.

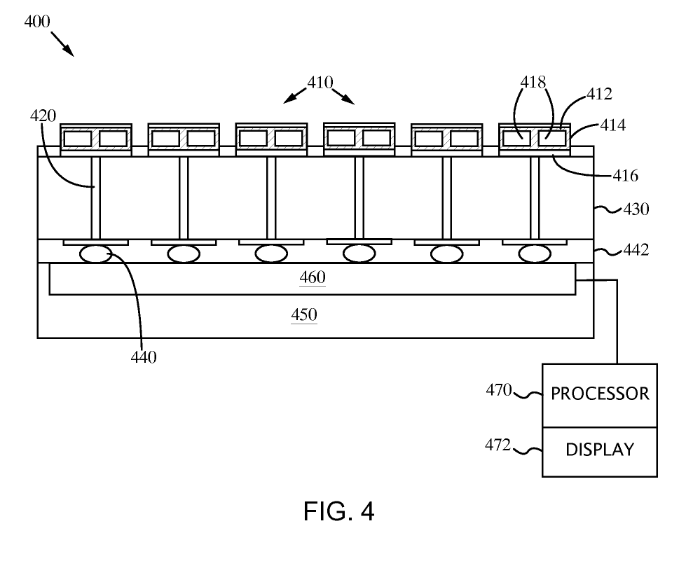

FIG. 4 is a schematic cross-sectional view of a sensor device 400 having an array of sensors 410 according to an embodiment of the invention. In this example, each sensor 410 contains two sensor elements, each of which has a membrane 412, support frame 414, substrate 416 and vacuum gap 418. The exterior surface of each membrane 412 is chemically functionalized. The sensors are designed for sensitivity to mass loading and stress loading by substances adsorbed or bound to the membrane 412, and for matching into the electronic circuitry such as a Pierce oscillator or any other type of oscillator that is used to detect the shift in the property of the membrane 412. Due to the functionalization of the surface, analytes adsorb or bind to the surface of the membrane 412 when they are present in the environment or a sample to which the sensor is exposed. Consequently, the operational characteristics (e.g., impedance or resonance frequency) of the sensor will be altered, and this sensor response is detected.

The presence or amount of substance(s) in a sample is measured by detecting the alteration of the operating characteristics of the resonating member (e.g., a membrane or cantilever). For example, an alteration in sensor characteristics can be detected by measuring the impedance of the sensor, or by measuring the change in the resonant frequency of the functionalized membrane 412. Interconnects 420 through wafer 430 provide electrical contacts from the sensors 410 to a wafer 450 with electronics layer 460. The interconnects 420 are separated from the electronics 460 by an underfill 442 and solder balls 440. (While solder bumps are shown in this figure, contacts may be made between wafer 430 and wafer 450 by any means known in the art, e.g. with an anisotropic conducting film).

The electronics layer 460 contains appropriate circuitry to drive and detect operational characteristics of the sensors 410, such as resonance frequencies of each membrane 412. Additional signal processing electronics or a processor 470 may be attached to the sensor electronics to further process the signals or data and to provide a humidity value as well as an indication of the presence or amount of other analyte(s). For example, the indication of the humidity value and the presence or amount of analytes may be shown via the display 472 in communication (wirelessly or with wires) with the processor 470. The processor 470 receives data representative of the resonance frequencies (e.g., frequency output signals from the sensors 410) to determine the presence or amount of analyte(s). The processor 470 may be a microprocessor included with the device 400. Alternatively, processing functions may be performed in a separate processor or external computer in communication with the electronics layer 460. The external processor or computer receives data representative of the measured resonance frequencies and determines the presence or amount of analyte(s). Alternatively, multiple processors may be provided, e.g., providing one or more processors in the device 400 that communicate (wirelessly or with wires) with one or more external processors or computers.

Some processing of data can be done near the sensor. For instance, time averaging or multiplexing or digitization can be all processed in the vicinity of the sensor before being transmitted to a computer or a circuit board with a multiprocessor. Specific algorithms can be loaded in memory to perform the same functions one would in a digital computer and then drive displays where colored outputs can be used to indicate level of detection or hazard. As in many sensors deployed today, such as RF tags and implanted medical devices, it is possible to use RF antennas to couple and provide power to the sensor. Once a sensor is powered, it senses its function, and then the output of the sensor is re-radiated to a receiving antenna. In this fashion, the sensor device 400 can be passive and remotely addressed.

In some embodiments, a CMOS provides the circuitry to detect the mass loading of the membrane 412 either through an impedance change, by direct measurement, resonance frequency measurement, or any of various other means. The outputs of various sensors can be multiplexed, then a frequency counter can measure the frequencies. These outputs can then be digitized and stored and processed in a processor. The processor then can display the variation of the resonant frequency versus time and provide results of analysis of sensed species based, for example, on previously loaded models of sensitivity of multiple sensors to various chemicals.

The material properties and dimensions of the functionalized membranes 412 contribute to their resonant frequencies. In some embodiments, a DC bias is applied to the functionalized membranes 412 to maintain a very high electric field in the vacuum gaps 418. For instance, a silicon membrane 12 μm in diameter and 0.4 μm thick may resonate at a frequency of 42 MHz. In some embodiments, each sensor is used as the resonant tank of an oscillator circuit, where the resonant frequency shift indicates the amount of mass loading on the membranes 412. The sensitivity of such a resonator is defined as the ratio of the frequency shift over the frequency: Δf/f=−Δm/2 m, where Δm is the change in mass (i.e., mass of the species that adsorbs or binds to the sensor) over the total mass of the membrane.

In one embodiment, a resonance frequency response of the fundamental mode is supplemented by also measuring a series of higher harmonics of the membrane. The viscoelastic properties of the sensing layer (e.g., polymer) are influenced by absorption/adsorption. These properties are extracted through measuring the frequency dependence of the damping and the amplitude of higher order modes, and these measurements provide chemical information in addition to the resonance frequency. For instance, different mass loadings, polymer swelling and changes in the young modulus are detected through the amplitude and Q-factor. Off-resonance response may also provide information on viscoelasticity through the slope of the mechanical response. In some instances, the membrane in a sensor can be engineered to enhance the response at some harmonics.

In another embodiment, gases or liquids are exposed over a layer of receptor material that adsorbs or binds the molecules of interest. The temperature of exposure will depend on the chemical desorption rate, and may be at room temperature or at lower temperatures depending on the molecule. After a set time, the sensor elements 410 may be heated either by thermal pulse or a linear programmed temperature ramp. During this heating, the molecules are desorbed and the change in resonant frequency and Q-factor shows a particular desorption profile similar to thermal desorption analysis commonly using spectrometric systems or gravimetrically (thermogravimetry). The temperature of desorption is an additional parameter that is sensitive to the chemical nature of the absorbent-absorbate interaction. After one thermal desorption cycle, a second subsequent cycle may be used to provide a reference calibration to be subtracted as a baseline from the first. The second thermal cycle reflects the thermomechanically induced change in resonance frequency.

Referring again to FIG. 2, the use of electrodes 112 provides a convenient method to heat the membrane 110. The small size and structure of the sensors ensures that low energy consumption, low thermal loads and fast (sub millisecond) response times can be achieved. The rapid response times aid resolution in the desorption profile. Temperature readouts of the sensors are also possible through integration of small thermocouples or the resistance of piezoresistive layers. The actual temperature profile during heating can provide information on phase transitions, heating or cooling effects. The sensor structure may be readily optimized to create an array of thermal sensor elements working on the bimetallic effect. Here temperature changes induce both changes in resonant frequency and static bending.

Sensor arrays may be configured as one-dimensional arrays of sensors or two-dimensional arrays of sensors. An advantage of a two-dimensional array is that an entire wafer may be populated with thousands of sensors. A one-dimensional array provides surface space, which may be used to integrate electronics side-by-side with the sensors. In some embodiments, a two-dimensional sensor array has electronics flip-chip bonded or fabricated under the sensor array. A sensor array with thousands of membranes may be useful in some embodiments for establishing the electrical impedance of the sensor, or for reducing the number of false alarms, if all the membranes in a sensor array are arranged to operate in parallel. If one sensor were to give a false indication, then the other sensors force a correct decision. Having thousands of sensors, many of which are functionalized in the same fashion, can also be used to reduce the false alarm rates and provide a more stable measurement of the presence of one or more analytes.

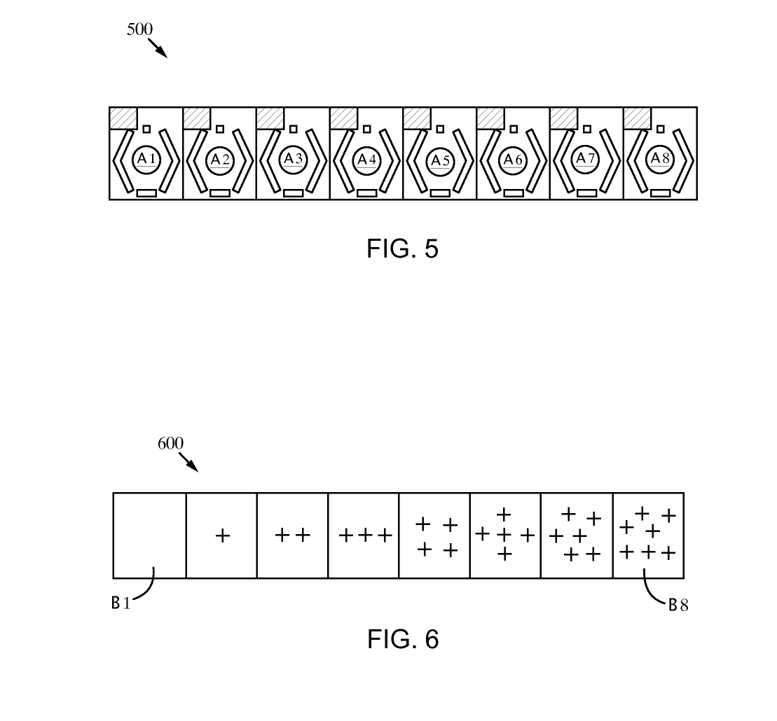

FIG. 5 shows a sensor array 500 having one row of eight resonator sensors A1-A8 functionalized with receptor materials. Sensors may be functionalized with receptor materials in various ways including the use of spin-coating, ink jet techniques, spotter techniques, microfluidics, self-assembly, shadow masking coupled with the above, or spraying in vacuum through movable mask arrays. In some embodiments, an array of sensors is functionalized with polymers having different properties so that the sensor array can sensitively detect and differentiate chemical compounds, and even complex mixtures. One may select and test an optimum set of polymers as receptor materials to generate a robust signature pattern for an analyte. Polymer receptor materials respond to gas-phase analytes in seconds to tens of minutes. The selection of polymers is preferably optimized to fit the mechanical properties of the resonating elements of the sensors (elasticity, density, thickness, etc.), so that detection time is minimized and sensitivity is maximized.

The surfaces of the resonating members (e.g., membranes) of the sensors A1-A8 may be functionalized in a manner that improves the receptor material's stability, control analyte adsorption kinetics, and ease application of the receptor material. For example, functionalization of the membranes may be performed by first coating the exterior surface of the membrane with a metal such as gold that aids adhesion of a receptor material to the surface. The receptor material may be deposited on the surface using various techniques, such as drop ejection, that enable multiple functionalizing liquids to be deposited on the sensor surface, and also reduce or eliminate cross-contamination between adjacent functionalized cells of an array. In some embodiments, neutral polymer gels may be used as carriers for receptor materials. Using this method, a variety of compounds that do not form stable films themselves can be applied through drop or spin coating on a neutral substrate such as silicon dioxide.

In order to control the location, applications, volume, and quantity of liquids deposited on the surface, one may use ink jet technology with functionalizing receptor materials instead of inks. It is sometimes preferable to use non-thermal deposition technology, if thermal ink jets would harm sensitive fluids. A drop ejector, for example, may be used to deposit the polymer over a sensor. The drop ejector is preferably used to deposit enough drops to cover a sensor. Different ejectors are used for different receptor materials so that adjacent sensors and membranes can be functionalized differently. One deposition technique is to use ultrasound based ejectors where a focused beam evolves a drop from a free surface.

Various other types of receptor materials may be doped or functionalized as required. These materials include, for example, polymers (co-polymers, bio-polymers), sol gels, and porous materials (silicon, zeolite, etc.). DNA, RNA, proteins, cells, bacteria, carbon nanotube arrays, catalysts including metals to enzymes, nanoclusters, organic and inorganic materials including: supramolecules, metal-organic complexes, or dendritic materials.

In one example of operation, each of the six analyte sensors A1-A6 has a different receptor material disposed on its resonating member (e.g., a membrane or cantilever). In this example, the receptor material on the first sensor A1 comprises polyethylenimine, the receptor material on the second sensor A2 comprises carboxymmethyl cellulose, the receptor material on the third sensor A3 comprises polyethylene glycol, the receptor material on the fourth sensor A4 comprises poly(styrenesulfonate), the receptor material on the fifth sensor A5 comprises polyvinylpyrrolidone, and the receptor material on the sixth sensor A6 comprises poly(methyl methacrylate).

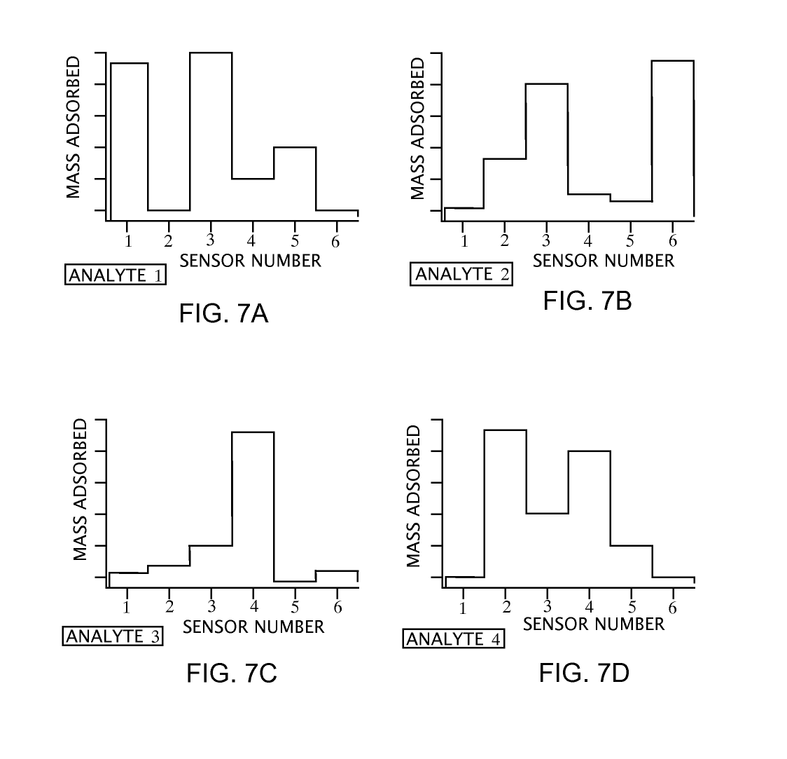

FIGS. 7A-7D are graphs showing patterns of masses adsorbed on functionalized sensors 1-6 for four target analytes. In this example, the analytes are volatile organic compounds (VOCs) that adsorb or bind in different mass patterns on the six analyte sensors having different receptor materials disposed thereon. FIG. 7A shows a response pattern of masses of a first analyte, acetaldehyde. FIG. 7B shows a response pattern of a second analyte, benzene. FIG. 7C shows a response pattern of a third analyte, formaldehyde. FIG. 7D shows a response pattern of a fourth analyte, naphthalene. At least one processor may be employed to determine the presence or amount of the analytes from the measured sensor responses.

Referring again to FIG. 5, the sensor array 500 also has at least two humidity sensors A7-A8. With multiplexed sensor arrays, such as CMUTs, it is possible to design differential sensors for humidity detection. The sensor A7 is coated with a hydrophilic receptor material, for example, poly vinyl alcohol (PVA). The sensor A8 is coated with a hydrophobic receptor material, such as Poly methyl methacrylate (PMMA) or polystyrene (PS). Due to the different affinities to water of the two polymer receptor materials on the sensors A7-A8, the sensor A7 that is coated with the hydrophilic receptor material shows a strong response to adsorbing or binding water molecules, whereas the sensor A8 that is coated with a hydrophobic receptor material shows little or no response to water. As a result, measuring the difference between the sensor responses of the sensors A7-A8 provides a useful measure of humidity. Since both sensors A7-A8 are in the same array 500 and are exposed to the same environment, interfering factors (e.g., temperature, interfering gases, vapors other than water, dust particles, etc.) are often similar or identical, so their effects may be canceled. In some embodiments, one or more corrections or adjustments are made to the humidity value to account for the interfering factors.

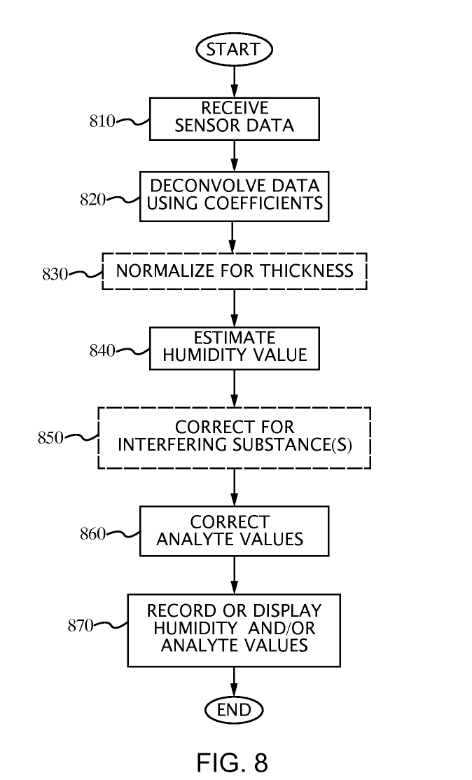

FIG. 8 is a flow chart showing steps of a method employing at least one processor to determine a humidity value (e.g., absolute humidity, relative humidity or specific humidity) and/or the presence or amount(s) of one or more analytes corrected for the humidity, according to some embodiments. In step 810, a processor receives data representative of the sensor responses (e.g., changes in resonance frequencies of the functionalized sensors due to mass loading of substances on the sensors).

In step 820, the processor deconvolves or de-convolutes the data using coefficients. This step can be performed with a set of equations, or more generally by a matrix. In a simple form, let A be the signal amplitude of sensor 1 indicating the sensor response, and X the quantity of unknown target substance adsorbed on the sensor 1. We can describe the dependence of amplitude A and unknown quantity X by a linear relationship and a coefficient aₓ so that A=aₓ X. If there is more than one substance on sensor 1, such as substances X and Y, then A=aₓ X+a_{y} Y. If we now let B be the signal amplitude of the second sensor 2 with a different receptor material and affinities bₓ and b_{y}, and assume that the second sensor is exposed to the same quantities X and Y of substances (since the sensors are proximate), then we can measure a different value B with the second sensor and solve two equations with two variables:

A=aₓX+a_{y}Y (1)

B=bₓX+b_{y}Y (2)

More generally, if we know the matrix of coefficients aᵢⱼ, then we can determine the masses of multiple substances Xⱼ if we have measured the amplitudes of I sensors Aᵢ using the vector product (equation 3):

Aᵢ=aᵢⱼ,Xⱼ (3)

If the number of sensors is greater than or equal to the number of target substances (e.g., water and target analytes), the equation can be solved. For example, for a thirty-two sensor chip, up to thirty-two different target molecules can be determined. In practice, however, one may choose some redundancy to improve accuracy. For example, one may choose to employ thirty-two sensors to target a more limited set of eight substances.

An array of sensors is preferably calibrated to determine the values of the matrix aᵢⱼ, with known substances of interest Xⱼ. The calibration data is stored either in a processor in the sensor array device or in a processor separate from the sensor array. In either case, the signals or data representative of the sensor responses may be deconvolved and analyzed to determine humidity and analyte values. In some embodiments, the processor determines respective patterns of masses on the sensors for each substance of interest (e.g., water vapor and target analytes). The sensor response data may be used with calibration curves to quantify a humidity value and the amount of one or more analytes (e.g., the ppm concentration of a specific gas), corrected for the affect of the humidity on the frequency response of the sensors.

In optional step 830, the processor normalizes the sensor response data to account for possible differences in the thicknesses of the receptor materials on the sensors. When polymers are used as receptor materials, the thickness of a coating of a polymer film on a sensor can vary in a practical thickness range of about 10 nm to 500 nm. The receptor materials disposed on members of a differential pair of sensors (e.g., the humidity sensors coated with hydrophobic and hydrophilic receptor materials) do not have to have the same thickness. For each sensor, we can measure its resonance frequency and compare it to the resonance frequency of an uncoated (bare) or passivated reference sensor. The difference in frequency between a coated sensor and an uncoated sensor is directly proportional to the film thickness of the polymer receptor material deposited on the sensor, and we can normalize the frequency shift due to humidity by the frequency shift caused by the deposited polymer film.

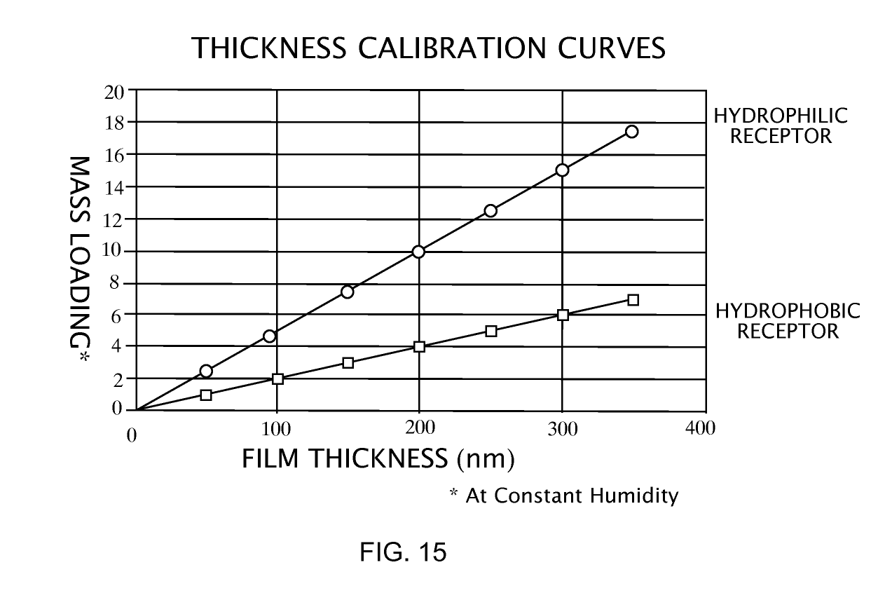

In general, the thicker the polymer film the more water (and other substances) can be adsorbed. A difference in film thickness between a pair of differential sensors A and B may affect the humidity reading. Since the frequency shift of a coated sensor compared to the resonance frequency of an uncoated sensor is proportional to the deposited mass (e.g., film thickness), and since this shift is known, we can correct for the effects of film thickness. In a preferred embodiment, the correction for film thickness is made by normalizing the measured responses of differential sensors A and B by the ratio of frequency shifts of sensors A and B, respectively, relative to a resonance frequency of at least one uncoated or passivated reference sensor. The resonance frequency of the uncoated sensor can be recorded in the factory prior to deposition of the polymer receptor material, or more practically, one can measure a resonance frequency of a passivated reference sensor in the array, described below. FIG. 15 shows examples of thickness calibration curves for masses of substances adsorbed or bound to the sensors as a function of the thickness of the polymer receptor materials on the sensors.

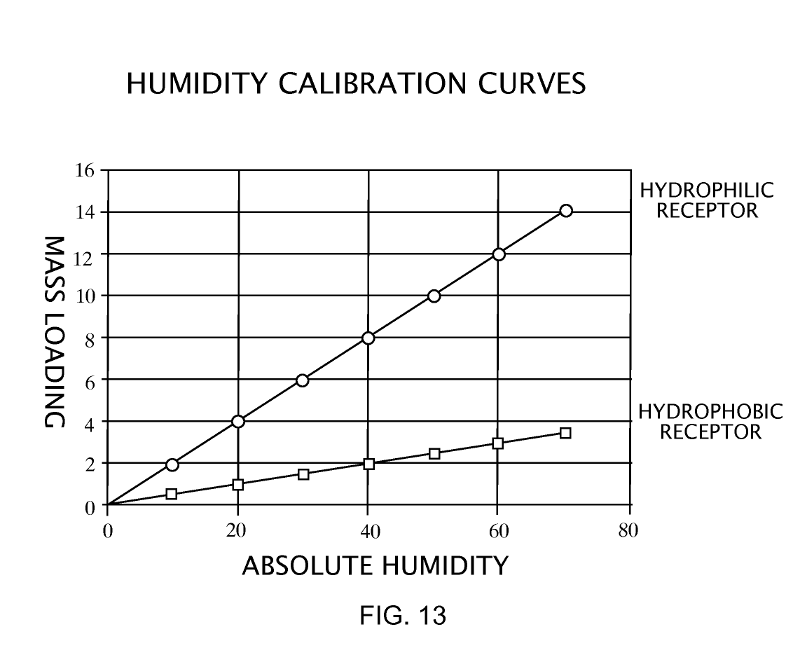

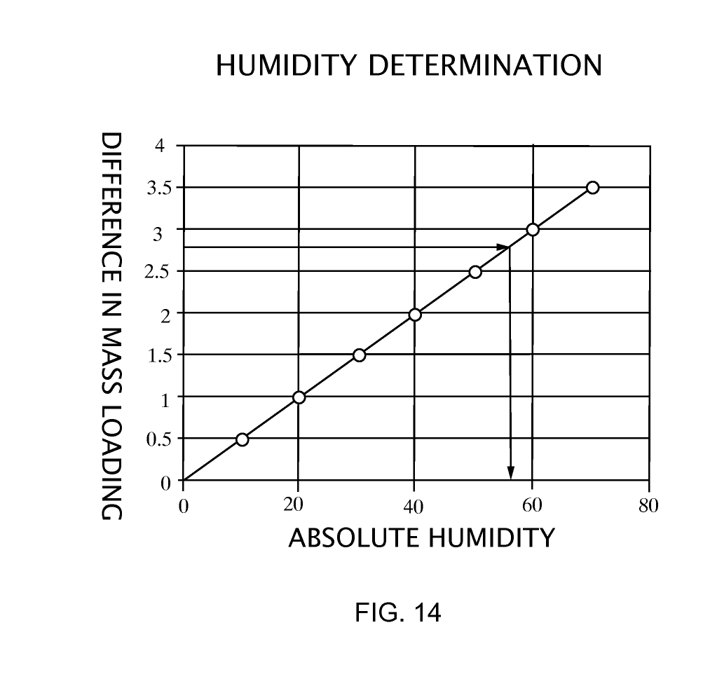

Referring again to FIG. 8, in step 840, the processor determines at least one humidity value (e.g., absolute humidity, relative humidity or specific humidity) according to the sensor responses. Preferably, the humidity value is determined from a difference in frequency response (e.g., a change in resonance frequency) between the sensor coated with a hydrophilic receptor material and the sensor coated with a hydrophobic receptor material. The difference in resonance frequencies of the hydrophilic and hydrophobic sensors, due to mass loading on the sensors when exposed to a sample, provides a useful indicator of the humidity, which may be determined from calibration curves. FIG. 13 shows examples of calibration curves in which the mass uptake, deduced from a frequency change of a first sensor coated with a hydrophilic receptor material, and the mass uptake, deduced from a frequency change of a second sensor coated with a hydrophobic receptor material, are calibrated as a function of humidity. The difference in mass uptake on the sensors may be used to determine the humidity value. FIG. 14 shows an example of a calibration curve in which the difference in masses loaded on a differential pair of hydrophilic and hydrophobic sensors is calibrated as a function of humidity.

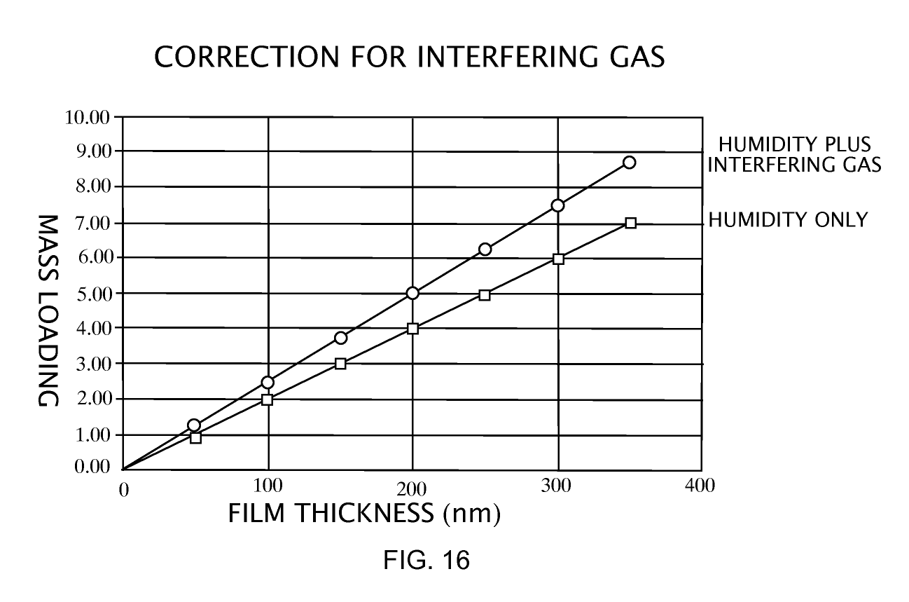

Referring again to FIG. 8, in optional step 850, the humidity value is corrected for the effects of interfering substance(s). It is conceivable that the environment to be measured contains interfering substances other than water. FIG. 16 is a graph showing an example of mass loading on a sensor as a function of the thickness of a receptor material on the sensor, with and without interfering substances. The measured mass uptake may be modeled as a sum of interfering substance X and humidity Y:

A=aₓX+a_{y}Y (1)

B=bₓX+b_{y}Y (2)

where aₓ is the affinity of the hydrophilic receptor material on sensor A to the interfering substance X, a_{y} is the affinity of the hydrophilic receptor material to water vapor Y, bₓ is the affinity of the hydrophobic receptor material on sensor B to the interfering substance X, and b_{y} is the affinity of the hydrophobic receptor material to water vapor Y.

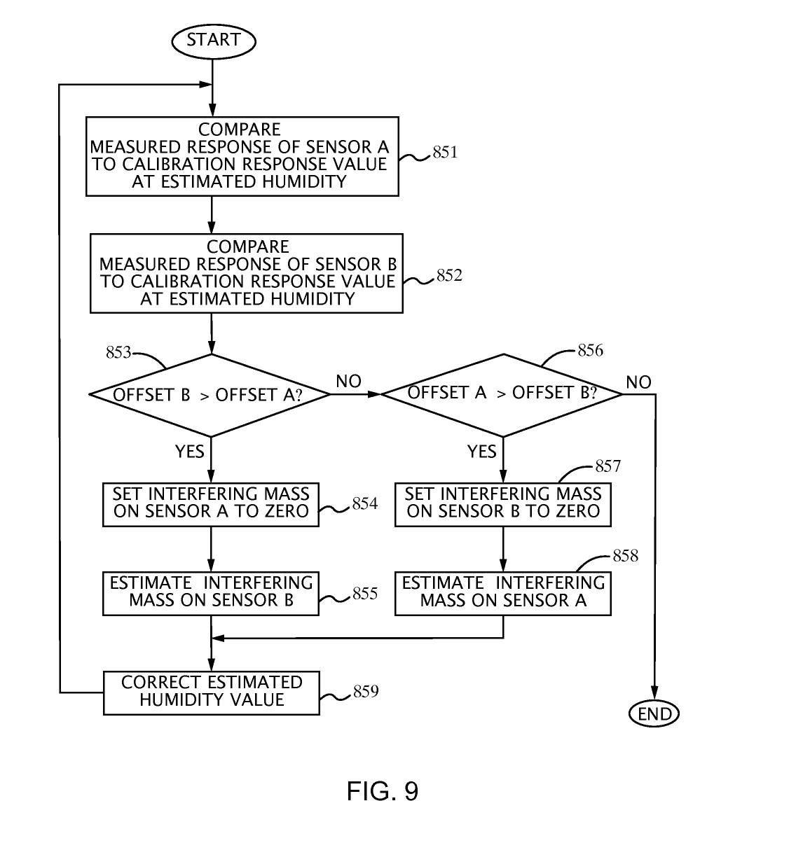

In the case where X=0 (no interfering substance present), the difference of the two signals A-B yields the humidity Y since the affinities a_{y} and b_{y} are known. In the case where the affinities aₓ and bₓ are equal (the hydrophobic and hydrophilic receptor materials have substantially equal or no affinity to the interfering substance X), the difference of the two signals A-B again yields the correct result for estimated humidity. The cases in which to consider a correction for interfering substances are when (aₓ>bₓ) or (aₓ<bₓ). If an interfering substance is present, then there are two possibilities. First, the substance may be identifiable from its mass pattern on the sensors, as described in step 820, and its mass may be subtracted out as appropriate when calculating the difference in the mass uptake on the sensors A-B to determine the humidity value. Second, the interfering substance may not be identified, in which case one may apply an algorithm to estimate the interfering mass(es) on the sensors. An example of such an algorithm is described below with respect to the flow chart of FIG. 9.

Referring again to FIG. 8, in step 860, the processor corrects the analyte values, determined from the patterns of masses on the sensors, for the effects of humidity. For example, the humidity value is subtracted from the analyte values to account for the affect of masses of water vapor on the sensors, so that the corrected analyte values more accurately indicate the mass loading of target analyte molecules on the sensors, less the effect of water molecules. In step 870, the analyte values (e.g., the ppm concentration of a specific gas) and the humidity value may be recorded in memory and/or displayed.

Preferably a look-up table or calibration curve is used to determine the humidity and analyte values according to the data representative of the sensor responses. The look-up table or calibration curve may be in a microprocessor included with the sensor array. In some embodiments, the microprocessor is programmed to store measured signal values and/or to calculate a humidity value and corrected analyte values. Alternatively, these functions may be performed in a separate processor or external computer in communication with the sensor array. Alternatively, multiple processors may be provided, e.g., providing one or more processors in the sensor array that communicate (wirelessly or with wires) with one or more processors or computers external to the array.

FIG. 9 is a flow chart showing steps of a method employing at least one processor to correct an estimated humidity value for the effects of interfering substances, according to some embodiments of the invention. In step 851, the measured response of sensor A coated with a hydrophilic receptor material is compared to a calibration response value A, determined from individual calibration data of sensor A at a humidity level substantially equal to the estimated humidity value. In step 852, the measured response of sensor B coated with a hydrophobic receptor material is compared to a calibration response value B, determined from individual calibration data of sensor B at a humidity level substantially equal to the estimated humidity value. The calibration data for sensors A and B were taken in a clean environment so that there was no interfering gas present. For the calibration data obtained in a clean lab, we have the equations:

A_{c}=a_{y}Y (4)

B_{c}=b_{y}Y (5)

In decision step 853, it is determined if the offset in values between the measured response of sensor B and the calibration value B_{c} at the estimated humidity is much greater than the offset in values between the measured response of sensor A and the calibration value A_{c} at the estimated humidity. There is extra mass signal from sensor A or B causing the offset if there is an interfering substance being adsorbed or bound to the sensor. If the offsets B-A do not differ by more than a desired maximum variance, then the algorithm proceeds to decision step 856. If the offsets B-A differ by more than a desired maximum variance, then the mass of interfering substance aₓX on sensor A is set to zero in step 854. In step 855, the mass of interfering substance bₓX on sensor B is estimated by solving equations (1) and (2) for bₓX and therefore determining the mass uptake of the unknown interfering substance bₓX on sensor B. In step 859, the estimated humidity value is corrected by re-calculating the humidity value based on the measured difference in signal values of sensors A-B, with the excess mass contribution of interfering substance bₓX on sensor B removed.

In decision step 856, it is determined if the offset in values between the measured response of sensor A and the calibration value A, at the estimated humidity is much greater than the offset in values between the measured response of sensor B and the calibration value B_{c} at the estimated humidity. There is extra mass signal from sensor A or B causing an offset if there is an interfering substance being adsorbed or bound to the sensor. If the offsets A-B do not differ by more than a desired maximum variance, then the algorithm ends. If the offsets A-B differ by more than a desired maximum variance, then the mass of interfering substance bₓX on sensor B is set to zero in step 857. In step 858, the mass of interfering substance aₓX on sensor A is estimated by solving equations (1) and (2) for aₓX and therefore determining the mass uptake of the unknown interfering substance aₓX on sensor A. In step 859, the estimated humidity value is corrected by re-calculating the humidity value based on the measured difference in signal values of sensors A-B, with the excess mass contribution of interfering substance aₓX on sensor A removed. The algorithm then returns to step 851 and repeats until the offset in values between the measured response of sensor B (less the mass contribution of interfering substance bₓX) and the calibration value B_{c} at the estimated humidity differs from the offset in values between the measured response of sensor A (less the mass contribution of interfering substance aₓX) and the calibration value A_{c} at the estimated humidity by less than a desired maximum variance in the offsets (e.g., within 3%).

FIG. 6 is a schematic, plan view of a sensor array 600 according to another embodiment of the invention. Each of the sensors B1-B8 is functionalized with a different receptor material, and each of the receptor materials has a physical property (e.g., hydrophobicity, hydrophilicity or polarity) relevant to its ability to bind or adsorb substances. The physical property of the receptor materials systematically increases or decreases in degree (e.g., in a pattern or increments) across the array 600 from the receptor material on a first one of the sensors B1 to the receptor material on a last one of the sensors B8.

In some embodiments, the physical property of the receptor materials increases or decreases in degree by substantially equal increments. By way of example, but not limitation, polyvinylidene fluoride is a fluorinated polymer with a monomer unit CH₂CF₂, where the CF₂ unit represents a strong dipole moment. The strong dipole moment attracts gases and organic molecules that carry a dipole moment on their own by virtue of an electrostatic interaction (e.g., alcohols, aldehydes or water). This polymer family may be modified to contain fewer or more fluorine atoms, thereby varying the degree of polarity. By creating a copolymer of the structure (CF₂CH₂)n . . . (CHFC)m, one can vary continuously the number of dipoles in the polymer chain by selecting different values of n and m. In addition to polarity, the degree of hydrophobicity of the receptor materials can be systematically varied by selecting a polymer system containing one or more benzene rings (or lack thereof) for each of the receptor materials on the sensors B1-B8.

An easy method to increase or decrease the degree of a physical property of the receptor materials (e.g., in substantially equal increments from one sensor in the array to the next) is to blend a functionalized polymer with a non-functional polymer. As an example, polyvinyl alcohol (PVA) has the monomer (C₂H₄O)ₓ. We can vary the degree of polarity or hydrophobicity (e.g., the number of active PVA monomers on each of the sensors B1-B8) by blending the functionalized polymer with a non-functional polymer. In this embodiment, the receptor material on the sensor B1 may be a 90/10 mix of the functionalized polymer with non-functional polymer, the receptor material on the sensor B2 may be a 80/20 mix, the receptor material on the sensor B3 may be a 70/30 mix, the receptor material on the sensor B4 may be a 60/40 mix, the receptor material on the sensor B5 may be a 50/50 mix, the receptor material on the sensor B6 may be a 40/60 mix, the receptor material on the sensor B7 may be a 30/70 mix, and the receptor material on the sensor B8 may be a 20/80 mix. There are many other suitable polymer families such as poly (vinyl halides), poly (vinyl alkenes) poly (vinyl ketones), poly (thio ethers), poly (vinyl esters), poly (siloxanes), and ionic liquids which allow the systematic variation of their physical properties via the pathway of copolymers or blended polymers. Possible measurements to determine the systematic increase or decrease in degree of a property (e.g., hydrophobicity, hydrophilicity or polarity) from one receptor material to the next in the sensor array 600 include, without limitation, the number of fluorine atoms per unit area per sensor or a measurement of the electronegativity according to Pauling or Allen.

The sensors B1-B8 have respective receptor materials that systematically decrease in degree of hydrophobicity (or increase in degree of hydrophilicity) from one sensor to the next in the sensor array 600. For example, the sensor B1 may have the most hydrophobic receptor material, and the sensor B8 may have the most hydrophilic receptor material in a graded panel of eight sensors. The sensors B1-B8 may function as both analyte sensors and humidity sensors based on their respective abilities to bind or adsorb water molecules and target analyte molecules. The affinity of molecules to a surface may vary depending on the “polar” or hydrophobic nature of the surface. A molecule or gas with a strong polarity easily attaches to a surface that has polar groups to establish coulomb interactions. For example, alcohol easily adsorbs on PVA (which contains OH groups). Similarly, a molecule with distributed electrons like benzene has a strong affinity to poly(isobutylene) (PIB). Polymer systems can be tailored with varying degrees of hydrophobicity (using co-polymers for example) to construct an array of sensors with receptor materials having gradual variations in their affinity to water.

In one example of operation, polyvinyl alcohol (PVA) is used as a receptor material to detect ethanol. Depending on the attach ratio of ethanol to PVA, the mass increase due to analyte on the sensors B1-B8 is determined by the number of ethanol molecules adsorbed on the surface. If we apply a graded panel of sensors in the array 600 where PVA is blended with a non-functional polymer, we can vary the degree of polarity or hydrophobicity (e.g., the number of active PVA monomers on the sensors B1-B8). As another example, polyisobutylene (PIB) having the monomer CH₂(CH₃)₂ is used in receptor materials to detect a target analyte benzene, C₆H₆.

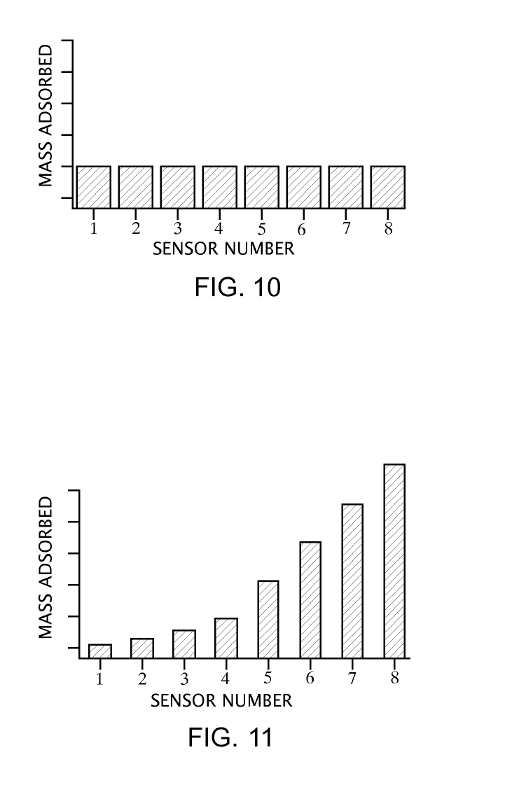

FIGS. 10-11 are graphs showing patterns of masses adsorbed on each functionalized sensor for target analytes. A target molecule like benzene shows little variation from sensors 1-8, as shown in FIG. 10. In contrast, a polar molecule like ethanol shows a characteristic dependence on the decreasing hydrophobicity of the receptor materials on sensors 1-8, as shown in FIG. 11. The systematic variation of a physical property of the receptor materials in the sensor array is analogous to information provided by a spectrometer or a chromatograph, and allows additional information to be deduced. One could deduce a charge to mass ratio (e/m ratio), similar to an electrophoretic chromatograph, which is characteristic to a particular molecule or molecule category.

In some embodiments, each of the receptor materials is a non-specific receptor with respect to one or more target analytes. With this type of non-selective “graded panel” of sensors in the array, one or more target analytes can adsorb or bind to the sensors with a pattern of masses specific for each of the target analytes. A mass pattern can be used to identify a target analyte that has been previously characterized, so that its pattern is known. If more than one target analyte is present in a sample (a mixture), then the individual known patterns can be deconvolved to separate the individual analytes.

Most measurements of airborne substances are affected by the presence of water. Water often competes with analyte molecules to adsorb or bind to the sensors, and therefore the measurement of humidity is useful to separate the effect of the target molecule (e.g., CO₂) from water molecules. Having an array of polymer receptor materials with varying polarity or hydrophobicity, the systematic adsorption of water can be predicted and therefore accounted for (high water adsorption on sensors with hydrophilic receptor materials and low water adsorption on sensors with hydrophobic receptor materials). With the use of a graded panel of sensors in the array 600, the affinity of a target analyte can be separated from the effect of water without an additional or separate humidity sensor. The sensors B1-B8 may function as both analyte sensors and humidity sensors based on their respective abilities to bind or adsorb water molecules and target analyte molecules.

As previously described in the flow chart of FIG. 8, signals or data representative of the sensor responses can be deconvolved and used to quantify the amount of a particular analyte, e.g. the ppm concentration of a specific gas. The analyte value is corrected according to the humidity value. In this embodiment, the humidity value is determined according to a difference between the sensor responses of three or more of the sensors in the array having respective receptor materials with varying degrees of hydrophobicity, in step 840. Preferably a look-up table or calibration curve is used to determine the humidity value according to the data representative of the responses of the three or more sensors. The look-up table or calibration curve may be in a microprocessor included with the sensor array. Alternatively, these functions may be performed in a separate processor or external computer in communication with the sensor array. Alternatively, multiple processors may be provided, e.g., providing one or more processors in the sensor array that communicate (wirelessly or with wires) with one or more processors or computers external to the array.

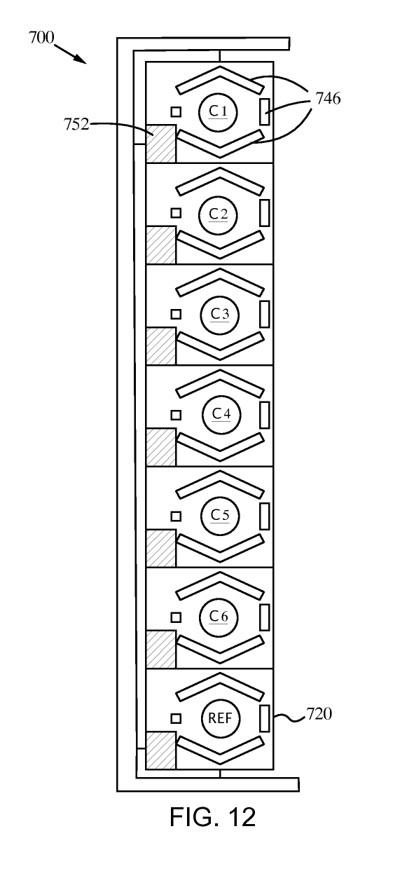

FIG. 12 shows an array of sensors according to another embodiment of the invention. In particular, this embodiment differs from previously described embodiments in that the sensor array 700 includes at least two differential pairs of humidity sensors. The first pair of differential humidity sensors comprises the first and second sensors C1-C2, with one of the sensors in the pair having a hydrophobic receptor material and the other having a hydrophilic receptor material. The second pair of differential humidity sensors comprises third and fourth resonator sensors C3-C4. The receptor material on the third sensor C3 is hydrophilic relative to the receptor material on the fourth sensor C4, and the receptor material on the fourth sensor C4 is hydrophobic relative to the receptor material on the third sensor C3. The humidity value is determined according to the difference between the sensor responses of the first and second sensors C1-C2 and a difference between the sensor responses of the third and fourth sensors C3-C4. This embodiment can be altered by increasing the number of humidity sensors to 6, 8 or more with alternate hydrophobic and hydrophilic coatings to provide 3, 4 or more pairs of differential sensors. The humidity value may be determined as an averaged number from the measured responses of the differential pairs of sensors, or by fitting the individual data in a backend processor.

The sensor array 700 may optionally include at least one reference sensor 720 to provide a reference signal. The number of sensors in the array that will be used as reference may be easily determined experimentally. Typically, it is expected that 1% to 50% of the sensors in the array will be non-functionalized and used as a reference. To mechanically isolate each of the sensors or reduce crosstalk between the sensors, vertical trenches 746 may be added between each of the sensors. The trenches 746 may be formed by any known etching process. Each of the sensors may also include wire bond pad areas 752 for electrical connections.

The reference sensor 720 is uncoated (bare) or has an intentionally passivated surface to make it substantially insensitive to adsorption or binding of airborne substances. The uncoated or passivated reference sensor provides a reference signal for corrections for the effects of polymer film thickness or for interfering factors (e.g., temperature, circuit changes, drift, etc.) and provides an additional input to deconstruct the signals or data from a multiplex sensor array. It is advantageous to include at least one pair of differential humidity sensors (such as the pair of humidity sensors C1 and C2 and the pair of humidity sensors C3 and C4) as well as at least one reference sensor 720 in the same sensor array 700 that is targeted to detect one or more specific analytes, such as carbon dioxide or VOCs.

Polymer receptor materials that detect CO₂ or VOCs are often sensitive to humidity, and it is useful to separately determine a humidity component in the sensor responses. In the sensor array 700, the pairs of differential humidity sensors C1-C2 and C3-C4 and the reference sensor 720 are combined with analyte-specific sensors C5-C6 to independently determine the humidity on the same chip. Analyte-specific sensors C5-C6 may be coated with receptor materials selected to adsorb or bind target analytes, such as CO₂ and/or VOCs. Since the measurements of sensor responses to a sample are made substantially simultaneously and under similar or identical conditions, an algorithm can be used to de-convolute the signals and deduce the presence or amount of analyte as well as the humidity value, as previously described with reference to FIG. 8. In this embodiment, the processor is programmed to determine the humidity value and correct the analyte values according to the difference between the sensor responses of at least one pair of differential humidity sensors and according to the sensor responses of at least one reference sensor.

In chemical sensing, especially sensors where mass is transduced via a frequency shift (e.g. quartz crystal microbalances or micromechanical analogs such as CMUTS, membranes, or cantilevers), significant frequency shifts may occur due to changes in temperature, or circuit time base, or due to undesired response of the sensors to other chemicals. The response of the reference sensor 720 having a passivated surface provides data to the processor to subtract the undesired response (e.g., due to temperature, circuit changes, drift, etc.) from the sensor responses of the analyte and humidity sensors. The chemical concentration that may be sensed by the device in this implementation may be both lower and more precise, since noise is removed (e.g., subtracted) from the responses of the other sensors.

In the simplest form, the differential scheme is a simple, algebraic subtraction as in the frequency shift example shown below:

Δf_{A}=Δf_{chemical}+Δfₜₕₑᵣₘₐₗ+Δf_{contamination}. (6)

Δf_{B}=Δfₜₕₑᵣₘₐₗ+Δf_{contamination}. (7)

Δf_{A}−Δf_{B}=Δf_{chemical}. (8)

However, the removal of unwanted response from the signal channel may include a more complex mathematical procedure to account, for example, for the differing response times of the humidity, analyte and reference sensors.

In one embodiment, a passivated surface of the reference sensor 720 may comprise a thin coating, such as a self-assembled monolayer (SAM), so that the sensitivity of the sensor is minimized. In another embodiment, the passivated surface of the reference sensor 720 may comprise a chemically inert layer, such as a fluorinated alkane polymer (such as Teflon) or a fluorinated SAM (such as (heptadecafluoro-1,1,2,2-tetrahydrodecyl)-triethoxysilane). In yet another embodiment, the reference sensor 720 is covered or sealed such that a resonating member of the reference sensor 720 is responsive to thermally induced changes in its resonance frequency while remaining protected from exposure to one or more of the substances in a sample.

Sensor arrays may be made with any of various known fabrication techniques including: SOI bonding, sacrificial layer, surface or bulk micromachining, and silicon on insulator bonding. The metal on the membrane is chosen to ensure the adhesion of the functionalizing receptor material. The sensor is preferably designed for maximum sensitivity while taking into consideration its mechanical loading and electrical interfacing into the integrated (or non-integrated) electronic circuitry. Sensors may be integrated with electronics in any of various known configurations including: flip chip bonding, elements constructed on top of electronics, or vice versa. The sensors may be fabricated with through wafer vias or trench isolated by etching through the backside using various well-known techniques for cMUT fabrication. Techniques suitable for fabricating such sensors are known in the art and are described, for example, in B. T. Khuri-Yakub and L. Levin, U.S. Pat. No. 5,828,394, which is incorporated herein by reference.

In operation, a sensor array can be mounted on a wall, ceiling or other portion of a fixed structure, incorporated into a hand-held device, or mounted on a moving vehicle, to name just a few methods of exposing the sensor array to a sample. The device may be configured as a humidity detector or as an analyte detector with humidity correction. Depending on the specific application, it may be used with or without active circulation of analyte-containing gas or liquid over the sensors to increase exposure of the sensor to analytes (e.g., chemicals) in the environment. A general guideline for high sensitivity in detection of small quantities of materials is to position the sensor as close to the sampling inlet as possible. The small dimensions of the sensor arrays readily facilitate the integration of the sensor at even millimeter distances from the sampling inlet. Ring arrays may be made with sensor elements that are 30 microns in diameter and where nine sensor elements are connected together to form a sensor, thus making a sensor that 100 microns by 100 microns in size. Resonant devices may be made with sub-100 micron dimensions.

It will be clear to one skilled in the art that the above embodiments may be altered in many ways without departing from the scope of the invention. Many different permutations or arrangements may be used to realize the device and method of the invention. For example, sensor arrays containing multiple sensors may have membranes with different resonant frequencies. A membrane operating at low frequency yields a sensor more sensitive to stress on the membrane, whereas a membrane operating at high frequency gives a sensor that is more sensitive to mass loading. Combining various operating frequencies in one sensor thus provides a sensor with a greater versatility.

In some embodiments, the amount of receptor material used to functionalize each sensor may be varied. For example, the number of droplets of receptor material placed on each sensor can be varied from one sensor to the next, thereby varying the thickness of the deposited receptor material. This variation in the amount or thickness of receptor material on each sensor establishes one more pathway to provide redundancy and enhance the accuracy of the sensor array (fewer false positives).

In some embodiments, electronics are integrated with sensor arrays, where multiple sensors are attached in parallel, and sensors are operated at different frequencies so that one output line may be used. For this purpose, different sensors may be built and operated at different frequencies. For example, a row of sensors can be made to resonate from 45 MHz to 55 MHz in 0.1 MHz intervals. Principles of dense wavelength division multiplexing (DWDM) may be used in such devices. A sensor for a Dog Nose type sensor may be made of one of multiple capacitor membranes that are all attached in parallel by virtue of having a metal electrode that covers all the sensors partially or fully. By altering the diameter of resonating elements, it is possible to change the frequency of operation. Having sensors operating at multiple frequencies can have advantages in electronic integration in transmitting information at different frequencies on the same channel, and in separating the influence of stress and mass loading on the shift in resonant frequency of a resonator.

In some embodiments, arrays of sensors are functionalized by a wide range of receptor materials. For example, for polymer receptor materials, some 500 polymers with a redundancy factor of 10 may be used. The specific responses including orthogonality of response, operation mode (temperature, integration times, etc.), lifetime and sensitivity of environment or other disrupting influences may be tested using the target molecules and interfering agents. Based on a self-optimization the system may then select the most sensitive polymer basis set (say 10 polymers) and optimum mode of operation. In this way, different customers, corporate (food, perfume), medical (breath, urine, blood analysis), security or military can obtain rapidly prototyped solutions. Incorporation of this data in a database for future development of prototypes and known response functions can be used.

In some embodiments, sensor arrays have a vast number of independently addressed sensors in the array to provide a massive redundancy. For instance, in an array of 5000 sensors, one can have a redundancy factor of 100 using 50 receptor and reference materials. This ensures that false alarms or defective elements in the arrays, which might miss the detection of analytes, are not an issue in device operation. The self calibration and learning feature of such arrays is also a mode which takes full advantage of redundancy. It permits defective elements and the control quarantine and analytical potential of the device to be optimized on the fly. Furthermore, it permits new threatening chemicals that may be identified to be quickly introduced into the detection capabilities of machines installed at different operational locations.

Accordingly, the scope of the invention should be determined by the following claims and their legal equivalents.

What is claimed is:

1. A device comprising:
a) a sensor array including at least first and second resonator sensors, wherein each of the first and second sensors has a receptor material disposed thereon for adsorbing or binding one or more substances, the receptor material on the first sensor being hydrophilic relative to the receptor material on the second sensor, and the receptor material on the second sensor being hydrophobic relative to the receptor material on the first sensor;
b) detection means for detecting sensor responses when masses of one or more of the substances are adsorbed or bound to the sensors; and
c) at least one processor in communication with the detection means for receiving signals or data representative of the sensor responses, wherein the processor is programmed to determine at least one humidity value according to the sensor responses.

2. The device of claim 1, wherein the sensor array further includes third and fourth resonator sensors having respective receptor materials disposed thereon, the receptor material on the third sensor is hydrophilic relative to the receptor material on the fourth sensor, and the processor is programmed to determine the humidity value according to the difference between the sensor responses of the first and second sensors and a difference between the sensor responses of the third and fourth sensors.

3. The device of claim 1, wherein the processor is programmed to determine the humidity value in further accordance with a frequency shift of the first sensor relative to a resonance frequency of at least one uncoated or passivated reference sensor and with a frequency shift of the second sensor relative to the resonance frequency of the reference sensor.

4. The device of claim 3, wherein the processor is programmed to normalize the humidity value according to a ratio of the frequency shifts.

5. The device of claim 1, wherein the sensor array further includes at least one reference sensor having an uncoated or a passivated surface, and the processor is programmed to determine the humidity value according to the sensor responses of the first and second sensors and according to at least one sensor response of the reference sensor.

6. The device of claim 5, wherein the reference sensor is passivated with a self-assembled monolayer (SAM), a fluorinated SAM, or a fluorinated alkane polymer.

7. The device of claim 1, wherein the processor is programmed to determine the humidity value according to at least one estimated difference in the masses adsorbed or bound to the sensors, and wherein the processor is further programmed to correct the humidity value for interfering substances adsorbed or bound to the sensors according to estimated quantities of the masses adsorbed or bound to the sensors that are not water.

8. The device of claim 7, wherein the processor is programmed to determine the estimated quantities by comparing the measured responses of the first and second sensors to calibration response values corresponding to a humidity level indicated by the humidity value.

9. The device of claim 1, wherein the sensor array includes at least first, second and third resonator sensors with respective receptor materials disposed thereon, the hydrophobicity of the receptor materials systematically increases or decreases in degree from the receptor material on the first sensor, to the receptor material on the second sensor, and to the receptor material on the third sensor, and the processor is programmed to determine the humidity value according to differences in the sensor responses of at least the first, second and third sensors.

10. The device of claim 9, wherein the processor is further programmed to determine from the sensor responses at least one analyte value indicative of the presence or amount of one or more analytes adsorbed or bound to the sensors and to correct the at least one analyte value according to the humidity value.

11. The device of claim 1, wherein the sensor array further includes at least one analyte sensor coated with a receptor material for adsorbing or binding one or more analytes, and the processor is further programmed to determine at least one analyte value indicative of the presence or amount of one or more of the analytes and to correct the analyte value according to the humidity value.

12. The device of claim 1, wherein the sensor array further includes a plurality of analyte sensors, and the processor is programmed to determine the presence or amounts of one or more analytes according to coefficients relating the sensor responses to respective masses of the analytes on the sensors and according to the humidity value.

13. The device of claim 12, wherein the sensor array further includes at least one reference sensor having an uncoated or passivated surface, and the processor is further programmed to determine the humidity value according to at least one sensor response of the reference sensor.

14. The device of claim 1, wherein each of the resonator sensors comprises a capacitive micromachined ultrasound transducer (cMUT).

15. The device of claim 1, wherein the sensor responses comprise changes in resonance frequencies, and the detection means comprises at least one detector for detecting resonance frequencies of the sensors.

16. A method comprising:
a) exposing a sensor array to a sample, wherein the sensor array includes at least first and second resonator sensors, each of the first and second sensors has a receptor material disposed thereon for adsorbing or binding one or more substances, the receptor material on the first sensor is hydrophilic relative to the receptor material on the second sensor, and the receptor material on the second sensor is hydrophobic relative to the receptor material on the first sensor;
b) detecting sensor responses to the sample; and
c) employing at least one processor to determine at least one humidity value according to the sensor responses.

17. The method of claim 16, wherein the sensor array further includes at least third and fourth resonator sensors having respective receptor materials disposed thereon, the receptor material on the third sensor is hydrophilic relative to the receptor material on the fourth sensor, and the humidity value is determined according to the difference between the sensor responses of the first and second sensors and a difference between the sensor responses of the third and fourth sensors.

18. The method of claim 16, wherein the humidity value is determined in further accordance with a frequency shift of the first sensor relative to a resonance frequency of at least one uncoated or passivated reference sensor and with a frequency shift of the second sensor relative to the resonance frequency of the reference sensor.

19. The method of claim 18, wherein the humidity value is normalized according to a ratio of the frequency shifts.

20. The method of claim 16, wherein the sensor array further includes at least one reference sensor with an uncoated or passivated surface, and the humidity value is determined according to the difference between the sensor responses of the first and second sensors and according to at least one sensor response of the reference sensor.

21. The method of claim 20, wherein the reference sensor is passivated with a self-assembled monolayer (SAM), a fluorinated SAM, or a fluorinated alkane polymer.

22. The method of claim 16, wherein the humidity value is determined according to at least one estimated difference in the masses adsorbed or bound to the sensors, and wherein the humidity value is corrected for interfering substances adsorbed or bound to the sensors according to estimated quantities of the masses adsorbed or bound to the sensors that are not water.

23. The method of claim 22, wherein the estimated quantities are determined by comparing the measured responses of the first and second sensors to calibration response values corresponding to a humidity level indicated by the humidity value.

24. The method of claim 16, wherein the sensor array includes at least first, second and third resonator sensors having respective receptor materials disposed thereon, the hydrophobicity of the receptor materials systematically increases or decreases in degree from the receptor material on the first sensor, to the receptor material on the second sensor, and to the receptor material on the third sensor, and the humidity value is determined according to differences in the sensor responses of at least the first, second and third sensors.

25. The method of claim 24, further comprising the steps of determining from the sensor responses at least one analyte value indicative of the presence or amount of one or more analytes adsorbed or bound to the sensors and correcting the at least one analyte value according to the humidity value.

26. The method of claim 16, wherein the sensor array includes at least one analyte sensor coated with a receptor material for adsorbing or binding one or more analytes, and the method further comprises the steps of determining at least one analyte value indicative of the presence or amount of one or more of the analytes and correcting the analyte value according to the humidity value.

27. The method of claim 16, wherein the sensor array further includes a plurality of analyte sensors, and the method further comprises the steps of determining the presence or amounts of one or more analytes according to coefficients relating the sensor responses to respective masses of the analytes on the sensors and according to the humidity value.

28. The method of claim 26, wherein the sensor array further includes at least one reference sensor having an uncoated or passivated surface, and the humidity value is determined according to the difference between the sensor responses of the first and second sensors and according to at least one sensor response of the reference sensor.

29. The method of claim 16, wherein each of the resonator sensors comprises a capacitive micromachined ultrasound transducer (cMUT).

30. The method of claim 16, wherein the sensor responses comprise changes in resonance frequencies.
